(19) United States
(12) Patent Application Publication
(10) Pub. No.: US 2025/0197270 A1
(43) Pub. Date: Jun. 19, 2025

(54) METHOD FOR MAKING AN OPENING IN A GLASS OR SAPPHIRE TIMEPIECE COMPONENT

(71) Applicant: Nivvarox-FAR S.A., Le Locle (CH)

(72) Inventors: Oualid FETTICHA, Bõle (CH); Julien BAILAT, Bienne (CH)

(21) Appl. No.: 18/939,886

(22) Filed: Nov. 7, 2024

(30) Foreign Application Priority Data
Dec. 19, 2023 (EP) 23218276.6

(51) Int. Cl. C03B 33/09

(52) U.S. Cl. CPC C03B 33/091

(57) ABSTRACT

One aspect of the invention relates to a method for producing an opening in a glass or sapphire timepiece component, according to which, in a first step, a glass or sapphire blank is produced or supplied, in a second step, a geometry of the opening is defined and the opening is cut in the form of a hole or contour by a laser filamentation method, and in a third step, the timepiece component containing the opening is separated from the scrap resulting from the filamentation method by chemical etching. The invention further relates to a watch having a glass or sapphire timepiece component with at least one opening made using this method.

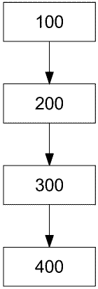

### CROSS REFERENCE TO RELATED APPLICATION

This application claims priority to European Patent Application No. 23218276.6 filed Dec. 19, 2023, the entire contents of which are incorporated herein by reference.

### TECHNICAL FIELD OF THE INVENTION

The invention relates to a method for making an opening in a glass or sapphire timepiece component.

The invention further relates to a watch comprising a glass or sapphire timepiece component with at least one opening made using this method.

The invention relates to the manufacture of timepiece components made of fragile materials such as glass or sapphire.

### TECHNOLOGICAL BACKGROUND

Machining timepiece components made of glass or the like is very delicate, and high scrap rates are observed during piercing operations or when making openings, particularly due to the presence of oversized chips.

### SUMMARY OF THE INVENTION

The purpose of the invention is to develop a method for piercing or for making an opening in a timepiece component made of glass or the like, without breaking or chipping it.

To this end, the invention relates to a method for making an opening in a timepiece component made of glass or sapphire, according to claim 1.

The invention further relates to a watch comprising a glass or sapphire timepiece component with at least one opening made using this method.

### BRIEF DESCRIPTION OF THE FIGURES

The purposes, advantages and features of the invention will be better understood upon reading the following detailed description given with reference to the accompanying drawings, in which:

The Figure is a flow chart showing the steps of the method according to the invention.

### DETAILED DESCRIPTION OF THE INVENTION

When producing watch dials made of glass or sapphire, in particular watch dials with an integrated solar cell, there is a need to develop a method for piercing the glass that allows for a precise contour, without chipping or chips, without draft, and that meets impact test conditions.

Such a piercing method is required in order to make a hole for passing the hands, or to make an aperture, index holes, or any other opening in a crystal or dial made of glass or sapphire or any other similar material, particularly enamel. In the description below, the generic term “glass” will be used to designate any of these materials.

A number of possible methods can be considered.

The first method consists of cutting the glass by laser, by successive ablation (etching) of the material: cutting is carried out by successive ablation of layers of glass in multiple passes, whereby the focusing of the laser requires the glass to be cut in a stair shape until it is pierced. This method therefore produces a relief that concentrates the mechanical stresses during impact testing and weakens the part.

A second method involves cutting glass by chemical machining using the “SACE” (spark assisted chemical etching) technique, which is a micromachining technology for non-conductive materials, mainly glass, based on heat-assisted etching. In general, during spark assisted chemical etching, material is removed at depth at a rapid rate of up to 100 μm/s for the first 100 μm, then slowing down for depths greater than 300 μm. The glass to be pierced is immersed in an alkaline solution (NaOH or KOH). A tool heated to between 500° C. and 600° C. is driven into the glass, with the thermal energy activating chemical etching of the glass around the tool. By moving the tool, the glass is pierced and cut according to the pattern imposed on the tool. This approach allows the glass to be chemically etched, which passes impact tests, but is particularly slow.

A third method involves cutting by laser filamentation and separation: the glass is first punched using a laser method referred to as filamentation, with a laser beam focused by a conical lens (Bessel lens). Laser filamentation involves the propagation of a laser beam in a transparent medium without diffraction, thanks to the optical Kerr effect, which generates a change in the refractive index of the medium in the presence of an intense laser field, resulting in the self-focusing of the beam. This regime is advantageously obtained by propagating a light pulse emitted by an amplified femtosecond laser. The glass is pierced end to end, at regular intervals (5 to 10 μm) by small holes a few um in diameter (in particular 2 μm to 3 μm). A CO₂ laser then passes over the punched outline a second time, which heats locally and, through thermal shocks, separates the glass along the filament path. This technique is very fast, but requires cutting lines to free the parts from the glass plate. It is therefore difficult, if not impossible, to remove a small disc from a glass plate without creating cutting paths to the disc.

To summarise:
the first laser cutting method makes it possible to obtain a geometry comprising holes and contours, with low productivity, and poor resistance to impacts and bending of the object produced.
the second cutting method by chemical machining of the “SACE” type makes it possible to obtain a geometry comprising holes and contours, with very low productivity, and good resistance to impacts and bending of the object produced.
the third cutting method by laser filamentation and separation, makes it possible to obtain a geometry comprising only contours, with high productivity, and excellent resistance to impacts and bending of the object produced.

The invention thus aims to develop a novel method that eliminates the drawbacks of the three methods mentioned above, and combines their advantages: the novel method should make it possible to obtain a geometry comprising holes and contours, with high productivity, and excellent resistance to impacts and bending of the object produced.

The subject matter of the invention is thus a fourth approach allowing the geometries that can be obtained by chemical spark assisted chemical etching (SACE) to be achieved, combined with the productivity of laser filamentation. Filamentation is used to produce the chosen geometry in the glass plate. The filament path is then selectively cut by etching in an alkaline solution (KOH or NaOH).

The method for producing an opening in a glass or sapphire timepiece component, according to the invention, comprises a first step 100 during which a glass or sapphire blank is produced or supplied. In a second step 200, a geometry of the opening is defined and the opening is cut in the form of a hole or contour by a laser filamentation method, in particular using a picosecond laser whose beam is focused by a conical Bessel lens. In a third step 300, the timepiece component containing the opening is separated from the scrap resulting from the filamentation method by chemical etching.

The filamentation step according to the invention is preferably carried out using a filamentation laser with ultra-short infrared pulses, in particular a picosecond laser or an infrared femtosecond laser.

The invention gives good results with a picosecond laser, with a frequency of between 170 and 1000 kHz, a pulse duration of less than 15 ps, and a wavelength of around 1064 nm, i.e. with a maximum deviation of 10% on either side of this nominal value. These parameters are well suited to the creation of an opening in a sapphire or glass crystal, dial or watch back.

For other experimental optical applications, a femtosecond laser can be used, with a pulse duration of between 100 and 200 femtoseconds and a frequency of between 0.5 Hz and 10 Hz, for example a laser with a pulse duration of 150 femtoseconds, a wavelength of 800 nm, and a frequency of 1 kHz, or a laser generating laser pulses with titanium-sapphire amplification, with a pulse duration of 120 femtoseconds, a wavelength of 800 nm, and a frequency of 1 kHz, or the like. It goes without saying that, however, the operating time is much longer than that achieved using a picosecond laser, which is sufficient and well suited to watchmaking applications.

In the second step 200, perforations are made in the glass, which perforations measure a few micrometres, in particular between 1 micrometre and 10 micrometres, and are spaced a few micrometres apart, in particular between 2 and 20 micrometres apart, more particularly between 5 μm and 7 μm apart.

Advantageously, the glass used is an alumino-borosilicate, for example a glass with a low coefficient of thermal expansion, similar to that of a silicon wafer, with high thermal stability, high optical quality, excellent dielectric properties and very low roughness, without alkali, arsenic or antimony.

Chemical etching is carried out in an alkaline solution, either potash or caustic soda, at a temperature of between 100° C. and 120° C. Multiple plates can be processed in parallel, offering high productivity despite long etching times of several hours, in particular 3 to 8 hours.

The cut edges produced thus have very few chips, which are less than 20 μm in size. This result is responsible for the very high impact strength properties obtained.

The invention further relates to a timepiece component made of glass or sapphire according to the method,
and more particularly, to a timepiece component on which a solar cell is deposited, for example a dial with a centre hole or an aperture.

More particularly, the opening is made in a timepiece component intended to receive a solar cell and, after the third step 300, in a fourth step 400, a solar cell is deposited on the glass of the component to produce a photovoltaic watch dial or crystal.

Once an opening such as a centre hole or an aperture has been made using the above method, a solar cell can easily be deposited on the glass to create a photovoltaic watch dial. The solar cell can either be deposited directly on the glass using methods known to a person skilled in the art, in the case of a thin-film solar cell, using technologies implementing amorphous silicon, perovskite (a perovskite photovoltaic cell is a type of photovoltaic cell in which the active layer consists of a material of general formula ABX3 with a perovskite structure in which A is a cation, typically of methylammonium CH3NH3+ (MA), of formamidinium CH(NH2)2+ or of caesium Cs+, B is a cation of tin Sn2+ or of lead Pb2+, and X is a halide anion such as chloride Cl−, bromide Br− or iodide I−1,2), CIGS (copper, indium, gallium, selenium or sulphur), cadmium telluride, or the like, or is added to the glass.

The invention further relates to a watch comprising a glass or sapphire timepiece component, in particular a crystal, a dial or a back, with at least one opening made using this method.

The method according to the invention makes it possible to obtain high productivity and, surprisingly, a mechanical strength of the parts that is significantly higher than that obtained by the currently used technique of SACE chemical machining or spark assisted chemical etching, or by laser cutting by ablation.

To summarise, the present invention makes it possible to produce all considered glass part designs, holes and contours, and offers high productivity. Moreover, the resistance of the parts to mechanical bending tests is surprisingly significantly superior to the other techniques mentioned above, and in particular to SACE chemical machining, with a force applied before breakage around four times greater.

The application of the invention to watch crystals and dials is particularly appropriate.

1. A method for producing an opening in a glass or sapphire timepiece component, comprising:
a first step, in which a glass or sapphire blank is produced or supplied;
a second step, in which a geometry of the opening is defined and the opening is cut in the form of a hole or contour by a laser filamentation method; and
a third step, in which the timepiece component containing the opening is separated from the scrap resulting from the filamentation method by chemical etching.

2. The method according to claim 1, wherein, in said second step, said laser filamentation method is carried out using a picosecond laser whose beam is focused by a conical Bessel lens.

3. The method according to claim 2, wherein an infrared picosecond laser is used with a frequency of between 170 and 1000 kHz, and a pulse duration of less than 15 ps.

4. The method according to claim 3, wherein said perforations are made in the glass with a wavelength of about 1064 nm.

5. The method according to claim 1, wherein in said second step (200), perforations are made in the glass, which perforations measure between 1 μm and 10 μm, and which are spaced between 2 μm and 20 μm apart.

6. The method according to claim 5, wherein said perforations are made in the glass and are spaced between 5 μm and 7 μm apart.

7. The method according to claim 1, wherein during said first step, an alumino-borosilicate is used, with a coefficient of thermal expansion similar to that of a silicon wafer, without an alkali, arsenic or antimony.

8. The method according to claim 1, wherein during said third step, chemical etching is carried out in an alkaline solution, at a temperature of between 80° C. and 120° C., for a duration of between 3 and 8 hours.

9. The method according to claim 1, wherein said opening is made in a timepiece component intended to receive a solar cell, and in that, after said third step, in a fourth step, a solar cell is deposited on the glass of said component to produce a photovoltaic watch dial or crystal.

10. The method according to claim 9, wherein said solar cell, which is a thin-film solar cell, is deposited directly on the glass.

11. The method according to claim 9, wherein said solar cell is attached to the glass.

12. A watch comprising a glass or sapphire timepiece component with at least one opening made using the method according to claim 1.
